(19) United States
(12) Patent Application Publication
(10) Pub. No.: US 2007/0172560 A1
(43) Pub. Date: Jul. 26, 2007

(54) Methods of controlling microorganisms in packaged foods

(75) Inventors: Warren Mirtsching, Ft. Collins, CO (US); R. Todd Bacon, Westchester, IL (US); John Hulse, Greeley, CO (US)

Correspondence Address: SHERIDAN ROSS PC, 1560 BROADWAY, SUITE 1200, DENVER, CO, 80202, US

(73) Assignee: SWIFT & COMPANY, Greeley, CO (US)

(21) Appl. No.: 10/597,854

(22) PCT Filed: Feb. 10, 2005
(86) PCT No.: PCT/US05/04639

§ 371 Date: Aug. 9, 2006

Related U.S. Application Data
(60) Provisional application No. 60/543,696, filed on Feb. 10, 2004.

(51) Int. Cl. A23L 1/16

(52) U.S. Cl. 426/325

(57) ABSTRACT

A method of controlling, reducing, or eliminating microorganisms including, but not limited to, fungi and bacteria associated with hygiene, food spoilage, and human pathogenesis on food surfaces after the foods have been packaged is achieved by exposing the microorganisms to a source of pulsed ultraviolet radiation through transmissible packaging. The duration of the pulses of ultraviolet radiation are in the range of picoseconds to microseconds at about 1 mJ/cm² to about 10 J/cm². Total energy irradiance is controlled in the case of foods with limited tolerance to such exposure.

### CROSS REFERENCE TO RELATED APPLICATION

This application claims priority to U.S. Provisional Patent Application Ser. No. 60/543,696 filed Feb. 10, 2005, which is incorporated herein in its entirety by this reference.

### FIELD OF THE INVENTION

The present invention relates to methods of controlling microorganisms and specifically to the reduction of microorganisms on the surfaces of packaged foods.

### BACKGROUND OF THE INVENTION

This invention relates to a method of controlling, reducing, or eliminating microorganisms by exposing them to ultraviolet (UV) radiation and, more particularly, to a method of surface disinfection of packaged foods and other objects associated with microbial contamination by applying ultraviolet (UV) radiation with short, high-intensity pulses.

During the preparation and processing of packaged food products, there exist opportunities for the food to be contaminated with microorganisms. While the introduction of microbial contamination to product surfaces may be minimized by judiciously following proper Good Manufacturing Processes and Sanitation Standard Operating Procedures, contamination of food surfaces may still occur during processing and preparation. Regulatory agencies charged with protecting the consumer have issued rules that provide for varying degrees of oversight of the packaging process, with the least regulatory intervention being exercised on those processors who adopt what is known as “post-packaging lethality” steps into their process. Thus, it would be advantageous for a processor to be able to control, reduce, or eliminate microorganisms from food products after the products are in their final packaging and the risk of subsequent product contamination is minimal.

### SUMMARY OF THE INVENTION

The present invention addresses the issues described above by applying ultraviolet sterilization technology to packaged food products. A flashlamp with a broad UV spectrum of sufficient power can be used to create a sterilizing effect as a result of rapid overheating of microorganisms due to the differential absorption of UV energy by the microorganisms as compared to the packaging or the underlying surface. The rapid overheating of the microorganism may cause the outer membrane or cell wall of the organism to burst, which is instantly lethal. Organisms not receiving an exposure sufficient to cause rapid destruction will be controlled by the known and accepted standard germicidal or bacteriostatic properties associated with exposure to UV radiation.

Currently, world-wide acceptance of the practice of food irradiation is growing. Since viruses, mycoplasmas, bacteria, and fungi can be destroyed by ultraviolet radiation, whether they are suspended in air, or in liquids, or deposited on surfaces, ultraviolet radiation has been used in a variety of applications such as (a) destruction of air-borne microorganisms for improving air hygiene, (b) inactivation of microorganisms located on surfaces or suspended in liquids, and (c) protection or disinfection of many products of unstable composition that cannot tolerate other conventional treatments such as by heat, gas, or chemicals.

The present invention provides improved methods of controlling, reducing, or eliminating microorganisms without using heat, gas or chemicals. These methods control, reduce, or eliminate microorganisms in packaged foods by exposing them to ultraviolet (UV) radiation with short high-intensity pulses. In a preferred embodiment, the method may be practiced on packaged foods and other objects subject to microbial contamination.

The methods of the present invention rapidly disintegrate microorganisms or have a non-repairable effect on nucleic acids, thereby reducing or eliminating cell division and/or processes resulting in proliferation of microorganisms on the surfaces of packaging and the surfaces of packaged foods. These methods have the advantage of effectively controlling microbial contamination in packaged foods extremely quickly.

### DETAILED DESCRIPTION OF THE INVENTION

The present invention advantageously addresses the problem of microorganisms on food surfaces of packaged foods by providing a method of controlling, reducing, or eliminating the microorganisms by applying short duration pulses of high intensity polychromatic ultraviolet light through the packaging material.

The present invention provides a method of inactivating microorganisms on food surfaces of packaged food products by utilizing short duration pulses of high intensity polychromatic ultraviolet light, such as that produced by systems available from Wek-Tec Pulsed UV Systems (Kehl/am Rhein, Germany). These methods utilize methods of producing pulsed UV light to inactivate and/or reduce pathogens on foods that have already been packaged.

The current operating theory in the food industry is that a processor should endeavor to clean/sterilize the surface of food products and then quickly package the food in order to minimize the opportunity for any undesired microorganisms to contaminate the food product. The shelf-life of many packaged food products, however, is still limited due to the inevitable event (using present technology) that some microorganisms remain present or are reintroduced through the inside of the package when the packaging operation is performed, or because the food product itself contains at least some residual microorganisms on its surface at the time of packaging. The subsequent growth of the microorganisms (whether spoilage or pathogenic in nature) contributes to the unsuitability of these packaged food products after a certain amount of time. Even the use of UV pulsed light on pre-packaged food products does not eliminate the potential for microbial contamination within the package—as such a “cleaning” technique, or post-packaging lethality is but one of many that have been employed in the practice of the above-referenced conventional “clean” packaging philosophy.

Other methods of pasteurizing packaged foods are suitable for some products but not others. One method of post-pasteurizing foods (pasteurizing after packaging) is the application of sufficient heat to inactivate microorganisms. While this may work on some food items, the addition of heat has detrimental effects on many products making such treatment impractical. Raw food products may be partially cooked at the surface, and most pre-cooked products will undergo changes due to the heat, which may adversely impact color, flavor, texture, or other organoleptic properties.

In the present invention, a variety of foods may not be adversely affected by the application of pulsed UV light after they are placed in their final packaging. The application of pulsed UV light may be part of the packing process, with the treatment being applied soon after sealing the packaging materials. Several more treatments with pulsed UV light are also within the scope of the present invention. For example, different intensities, durations, types, or the number of pulses of UV may be employed at different times (whether widely spaced or not) to achieve the overall objective of having a packaged food product that exhibits far less microbial contamination than would otherwise be the case using conventional operations, and with little or no ill effects on the organoleptics of the product.

In one embodiment of the present invention, meat products are treated with pulsed ultraviolet light immediately after meat is placed in a heat sealed plastic film that is sealed under vacuum. Any suitable type of film may be employed, providing: the film permits a sufficient amount of desirable UV light to pass therethrough to accomplish the objective of inhibiting, if not killing, bacteria that may be present on the packaged food product surfaces; the film is not significantly degraded by the irradiation operation so that the film loses it packaging characteristics; and, the film be of a thickness so that it maintains the closed environment of the package during and after the UV irradiation procedure. In a preferred embodiment, the film consists of a co-extruded blend of polyolefins including SARAN™, and is passed through a chamber that is part of the conveyor processing line after the vacuum packaging machine but before the product is placed in an opaque shipping bag or box. The packaged product would be exposed to pulsed ultraviolet light having wavelengths of between about 200 nm and about 400 nm with durations of between about 0.1 ns and about 1,000 ns, and with energy densities of between about 0.1 J/cm² and about 10 J/cm². Each package would preferably be treated with fewer than about 100 pulses, such pulses coming from a plurality of UV flashlamps arranged within a cabinet or chamber such that all surfaces of the packaged product are exposed sufficiently to achieve the desired effect. Individual pieces of packaged product can be conveyed through the chamber at rates as large as 45 pieces per minute or greater, since the treatment takes less than about one second per piece and since multiple pulses of UV light can be generated in less than about one second. The chamber would be properly constructed such that the products could enter and exit the chamber without the UV radiation escaping during a continuous process. The conveyor carrying the product through the chamber would have a high percentage of open area so as to minimize the shadows created by the conveying mechanism, and the product could automatically be repositioned on the conveyor for additional treatment so that shadows are eliminated and all surfaces receive the minimum desired exposure.

As one of skill in the art will appreciate, the food item should be properly placed so that it is exposed to the desired amount and intensity of the radiation. As such, the distance between the UV flashlamp and the food product may be varied depending upon a variety of different criteria, including, but not limited to, the type of food involved, the thickness and type of plastic packaging involved, and the target microorganism possibly present in the packaged product.

Preferably, the UV radiation procedure would be performed right after a food product is packaged, but before any microbial population that may be present has time to proliferate or participate in biofilm formation. Thus, the UV emitter and its chamber or cabinet is positioned to irradiate a conveyor belt that conveys product to a desired boxing or further packaging area. While not bound by theory, it follows that the application of high intensity pulsed UV light could be performed on frozen packaged products. The process could be used on products after they have left the original packing plant; for example if a product was subsequently re-packaged at a distribution center or at retail stores.

The foregoing description of the present invention has been presented for purposes of illustration and description. Furthermore, the description is not intended to limit the invention to the form disclosed herein. Consequently, variations and modifications commensurate with the above teachings, and the skill or knowledge of the relevant art, are within the scope of the present invention. The embodiment described hereinabove is further intended to explain the best mode known for practicing the invention and to enable others skilled in the art to utilize the invention in such, or other, embodiments and with various modifications required by the particular applications or uses of the present invention. It is intended that the appended claims be construed to include alternative embodiments to the extent permitted by the prior art.

What is claimed is:

1. A method of controlling microorganisms on the surface of food comprising irradiating the surface of a food after packaging said food, with at least one pulse of ultraviolet light.

2. The method of claim 1, wherein the food packaging comprises a co-extruded blend of polyolefins.

3. The method of claim 1, wherein said microorganisms are controlled by destructively altering nucleic acid structures within the microorganism.

4. The method of claim 1, wherein said microorganisms are controlled by rupture or disintegration of said microorganisms with said irradiation without alteration of surface properties of said food.

5. The method of claim 1, wherein said light pulses have a duration ranging from about 0.1 ns to about 1,000 ns.

6. The method of claim 1, wherein said microorganisms are irradiated with fewer than about 100 of said light pulses.

7. The method of claim 1, wherein said food is irradiated for less than about one second.

8. The method of claim 1, wherein said light pulses have energy densities ranging from about 0.1 J/cm² to 10 J/cm².

9. The method of claim 1, wherein said at least one light pulse has a wavelength between about 200 nm and about 400 nm.

10. A method of reducing microorganisms on the surface of a packaged food object comprising irradiating said microorganisms on the surface of a food object with a plurality of ultraviolet light pulses for less than about one second, said light pulses having a duration between about 0.1 ns to about 1,000 ns, and wherein said light pulses have energy densities between about 0.1 J/cm² and about 10 J/cm², and wherein said microorganisms are reduced by said irradiation without affecting surface characteristics of said food object.

11. The method of claim 10, wherein the food packaging comprises a co-extruded blend of polyolefins.

12. The method of claim 10, wherein said light pulses have a wavelength between about 200 nm and about 400 nm.

13. The method of claim 10, wherein said microorganisms are irradiated with fewer than approximately 100 said light pulses.

14. A method of killing microorganisms on the surface of a packaged food object comprising
irradiating microorganisms on a surface of a food object with a plurality of ultraviolet light pulses for less than about one second,
wherein the food packaging comprises a co-extruded blend of polyolefins;
wherein said light pulses have a duration between about 0.1 ns to about 1,000 ns; wherein said light pulses have energy densities between about 0.1 J/cm² and about 10 J/cm²;
wherein said light pulses have a wavelength between about 200 nm and about 400 nm; and,
wherein said microorganisms are reduced by said irradiation without affecting surface characteristics of said food object.

15. The method of claim 12, wherein said microorganisms are irradiated with fewer than about 100 said light pulses.
